(19) United States
(12) Patent Application Publication
(10) Pub. No.: US 2010/0005620 A1
(43) Pub. Date: Jan. 14, 2010

(54) TWIN CASTOR WITH COMMON WHEEL MOVEMENT

(75) Inventor: Andrew Gray, York (GB)

Correspondence Address: BROOKS KUSHMAN P.C., 1000 TOWN CENTER, TWENTY-SECOND FLOOR, SOUTHFIELD, MI, 48075, US

(73) Assignee: GRAY MATTER (ALPHA) LIMITED, Shipton by Beningbrough, York (GB)

(21) Appl. No.: 12/294,264

(22) PCT Filed: Mar. 5, 2007
(86) PCT No.: PCT/GB2007/000775

§ 371 Date: Jul. 30, 2009

(30) Foreign Application Priority Data
Mar. 24, 2006 (GB) 0605829.1

(51) Int. Cl. B60B 33/00; B21D 53/26

(52) U.S. Cl. 16/47; 29/894.3

(57) ABSTRACT

A method and apparatus are disclosed for providing a castor for a shopping cart. The apparatus includes a first wheel member and a second wheel member arranged in a side-by-side configuration on either side of a central wheel housing, each of the first and second wheel members is arranged to rotate about a common axis. The apparatus also includes an elongate sleeve member extending through the housing and connecting the first and second wheels together whereby the wheels rotate together.

The present invention relates to a method and apparatus for providing a castor of the type which may be used for a shopping cart or other object. In particular, but not exclusively, the present invention relates to a castor having multiple wheel component parts which are connected together.

There are many instances known in which vehicles, or other such means of transportation, which are provided with one or more wheels should have their movement inhibited or prevented. A known way for achieving this is to provide a brake mechanism on one or more of the wheels. When motion of a vehicle or object is to be slowed or stopped a signal is transmitted to a brake which is applied. The application of the brake retards rotation of a wheel.

Many different types of braking mechanism are known and the manner in which braking is achieved is often dependent upon the type of vehicle which is to be slowed or stopped.

It will be understood that embodiments of the present invention are generally applicable in the sense that they can be adapted to retard rotation of one or more wheels of any type of means of transportation or object which is provided with the facility to move. However, the present invention is particularly well suited to retarding rotation of at least one wheel of a castor for a shopping cart. Shopping carts, sometimes referred to as shopping trolleys, are well known and are provided by supermarkets or other retail establishments for shoppers to transport goods to be purchased in a very convenient manner. However, supermarkets are known to have a problem in that from time to time shopping carts may be removed from premises by unauthorised personnel. Such removal costs retail businesses money to either replace or locate the trolleys and return them to a desired location.

Shopping carts are typically provided with four castors each of which includes one or two wheels arranged to rotate about a common axis between forks. The forks are connected at a common point to the shopping cart.

Many methodologies and apparatus have been suggested in the past for avoiding the unauthorised removal of shopping carts. Some of these involve the inclusion of a braking assembly in at least one castor of the shopping cart. However, such braking assemblies can be costly to produce and are prone to failure from time to time. Another problem is that the environment in which the shopping cart operates is a relatively inhospitable environment. For example, shopping carts are often pushed or pulled over very uneven surfaces where a jarring motion may be transferred into the castor of the shopping trolley. This makes parts within the castor prone to failure and can cause a brake to invalidly deploy or unset.

Some known braking assembles for wheels include a latch-like assembly in which a latch can be positioned in one of two positions. In a first position a brake operates to brake a wheel thus retarding rotation of the wheel. In another position the brake is not applied. Many known latching assemblies are prone to failure either because of the environmental harshness noted above or because unauthorised personnel will attempt to disable the latch mechanism.

In this sense latching mechanisms per se are known for a whole host of different applications. As such these latching mechanisms are arranged to select one or more states. Once a state of a latch is selected this determines operation of some machinery or other component parts in the apparatus where the latch mechanism is located. However, many types of latch mechanism are complex which makes them costly to produce and maintain or means that they are prone to failure. It will be understood that whilst embodiments of the present invention are described by way of example with respect to a latching mechanism applicable to select a braking state for a wheel of a shopping cart, embodiments of the present invention are generally applicable to circumstances where a latch mechanism is required to select one or more states of operation of particular equipment.

Different types of castor are known. These generally include a central wheel which restricts the uses which can be made of the castor. Single wheel castors are also prone to skidding and/or slipping on a surface. Furthermore, single wheel castors tend to have a limited space within them within which auxiliary equipment can be used for example to generate power in a castor or provide a braking system for the castor may be located.

It is an aim of the present invention to at least partly mitigate the above-mentioned problems.

It is an aim of embodiments of the present invention to provide a castor of the type which may be fitted to a shopping cart or other target object and which includes at least two wheel members separated by a wheel housing. The wheel housing can be used to store auxiliary equipment which may itself be used for a wide variety of reasons. For example, the auxiliary equipment can be used to generate power or provide a braking system to avoid unauthorised removal of the object/shopping cart to which the castor is attached.

It is also an aim of embodiments of the present invention to provide a castor in which multiple wheel members are secured together so as to rotate together. In this way, if one wheel is located on a surface which is smooth and which would otherwise mean the wheel would slip or skid, the remaining wheel which may be resting on a different surface can be used to drive the wheels of the castor.

According to a first aspect of the present invention there is provided an apparatus for providing a castor for a shopping cart, comprising:

a first wheel member and a second wheel member arranged in a side-by-side configuration on either side of a central wheel housing, each of said first and second wheel members being arranged to rotate about a common wheel axis; and

an elongate sleeve member extending through said housing and connecting said first and second wheels together whereby the two wheels rotate together.

According to a second aspect of the present invention there is provided a method for manufacturing a castor for a shopping cart, comprising:

providing a first wheel member and a second wheel member;

arranging each wheel member in a side-by-side configuration on either side of a central wheel housing, each of said first and second wheel members being arranged to rotate about a common wheel axis; and

connecting said first and second wheel members together via an elongate sleeve member whereby the two wheels rotate together.

Embodiments of the present invention provide a castor for a shopping cart or other object which includes a housing which can be used to carry auxiliary equipment used for a variety of reasons. For example, the housing can store braking equipment or power generating equipment. Advantageously, the two wheels are locked together so as to rotate together. This means that a constant rotation of a common axis can be maximised. This rotation can be harnessed in the auxiliary equipment.

Embodiments of the present invention will now be described hereinafter, by way of example only, with reference to the accompanying drawings, in which:

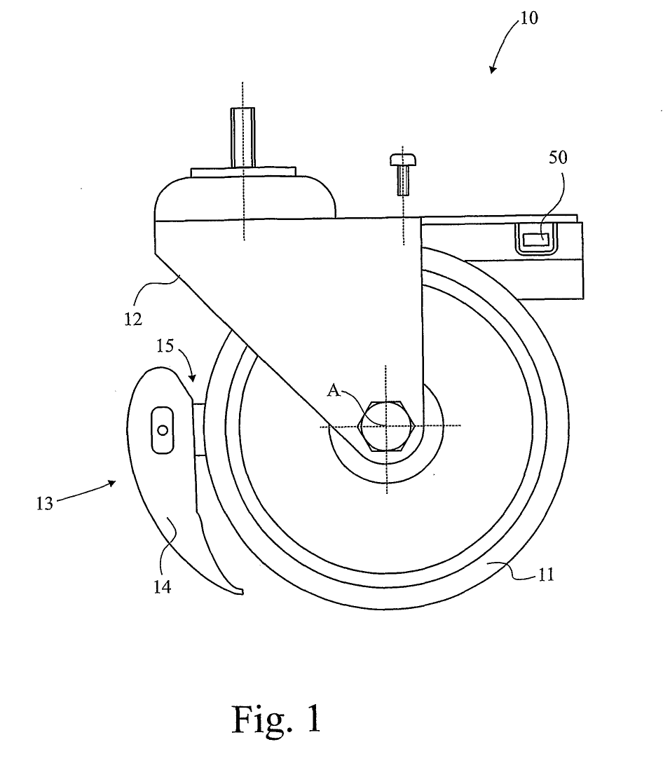

FIG. 1 illustrates a castor;

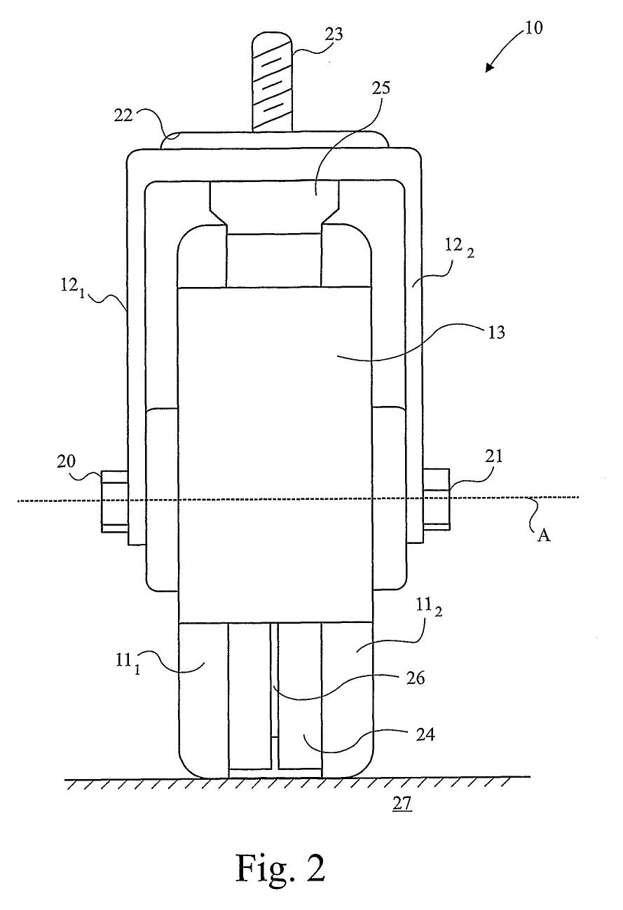

FIG. 2 illustrates another view of a castor;

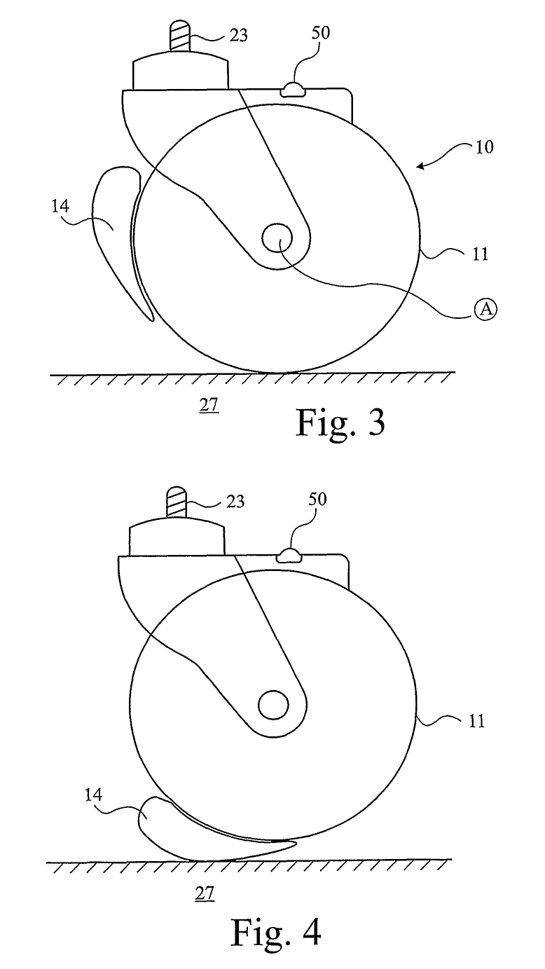

FIG. 3 illustrates a non-braking position of a braking member;

FIG. 4 illustrates a braking position of a braking member;

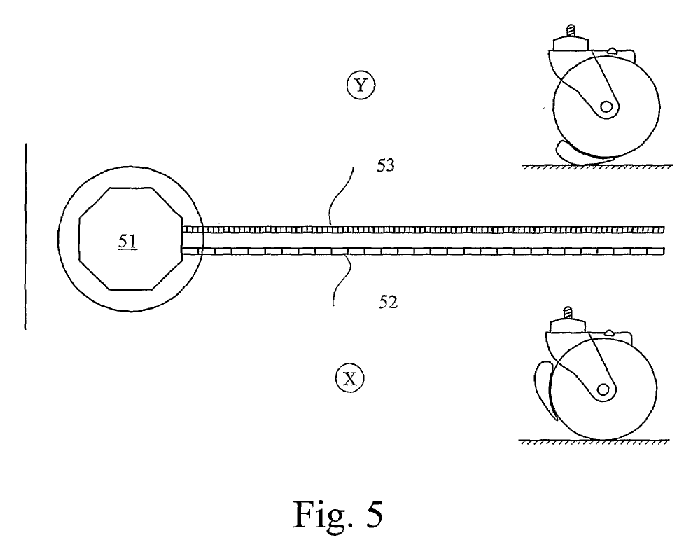

FIG. 5 illustrates transmission of a set and unset signal;

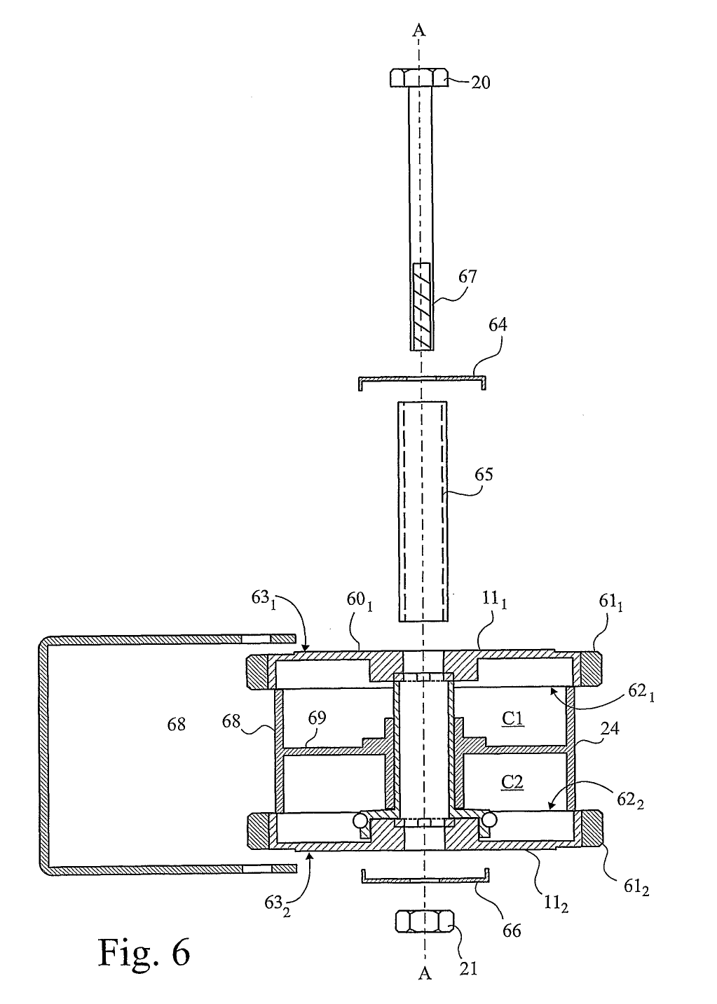

FIG. 6 illustrates parts of a castor;

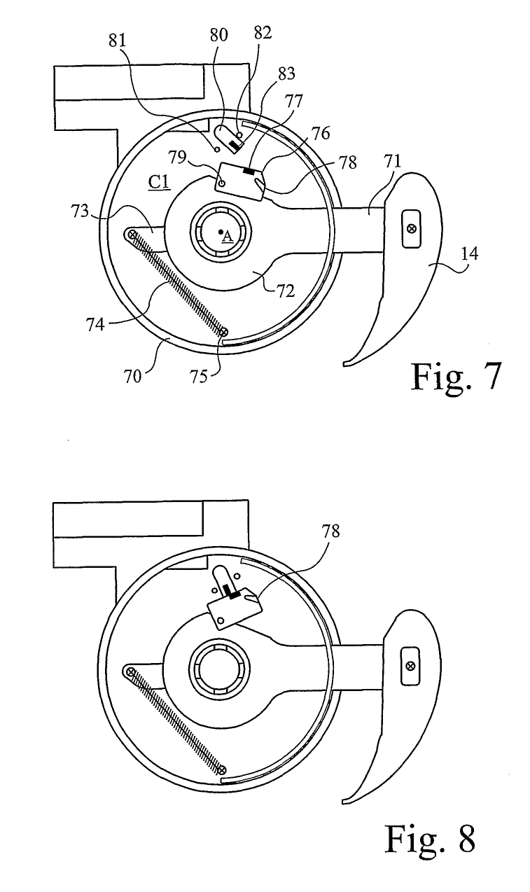

FIG. 7 illustrates a latching mechanism in a non-deployed state;

FIG. 8 illustrates a latching mechanism in a deployed state;

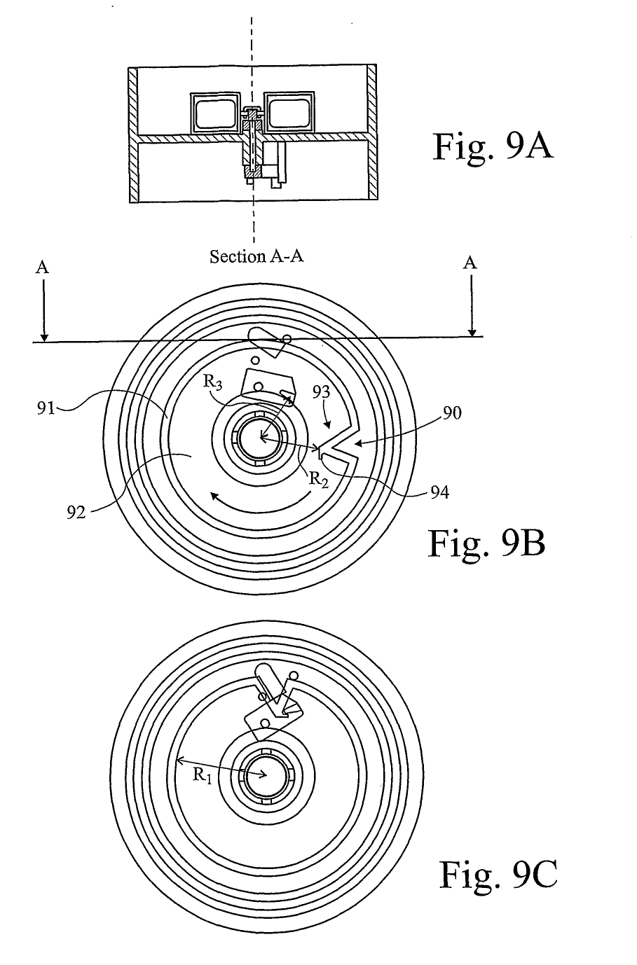

FIGS. 9A, 9B and 9C illustrate an inner surface of a wheel;

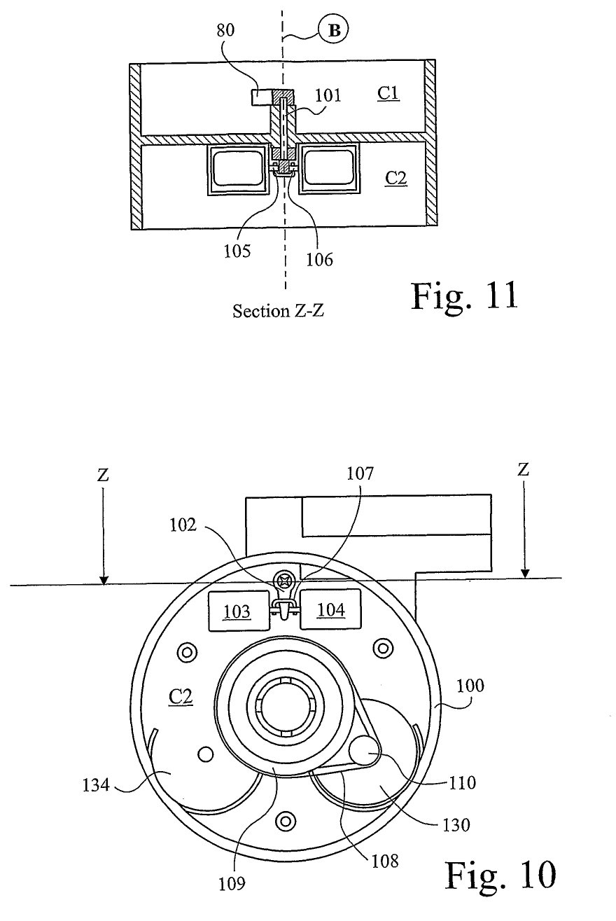

FIG. 10 illustrates a compartment in a castor housing;

FIG. 11 illustrates a latch actuator;

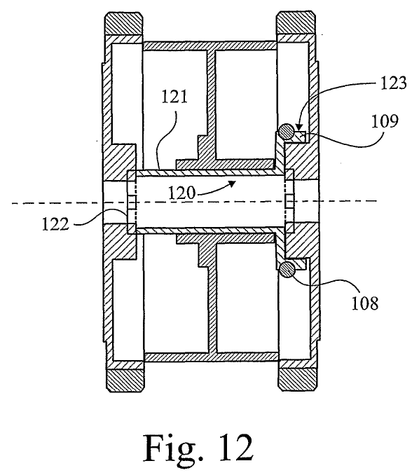

FIG. 12 illustrates how wheels are connected together;

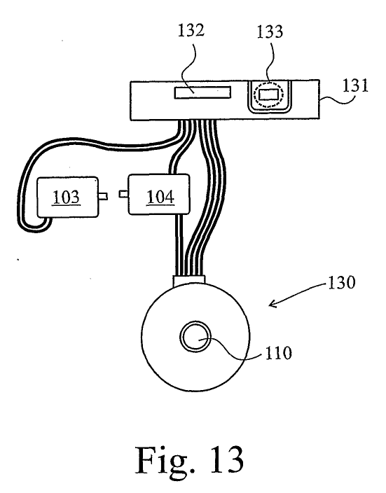

FIG. 13 illustrates power supply in a castor; and

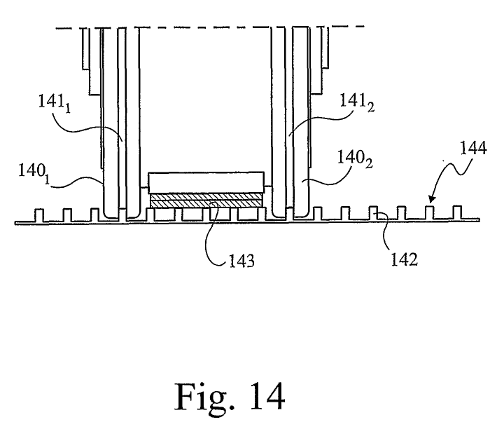

FIG. 14 illustrates motion of a castor on a travelator.

In the drawings like reference numerals refer to like parts.

FIG. 1 illustrates a side view of a castor 10. The castor includes two wheels 11 held between forks 12 and able to rotate about a common wheel axis A. It is to be understood that the present invention is not restricted to use of two wheels. Rather the invention is generally applicable to castors including one or more wheels. A braking member 13 includes a brake foot 14 at an end region 15 of an arm thereof. It will be understood that castors of this type have many potential uses such as, for example, facilitating movement of shopping carts where castors 10 of this type would be located in the four underside corners of the shopping cart. However, such castors may be applied generally to the underside of very many different types of equipment or vehicles such as, for example, on hospital equipment, furniture or office equipment.

FIG. 2 illustrates another view of the castor 10. Here the two forks 12₁, 12₂ may more clearly be seen to bridge the wheels 11. In particular in FIG. 2, the castor can be seen to include two wheels 11₁, 11₂ which are both arranged to rotate about a common wheel axis A. The two wheels are secured to the forks of the castor by a nut 20 and corresponding bolt 21. A first end of each fork 12 is secured to the nut and bolt whilst the other ends of the forks form a fork body 22 towards the top of the castor. A securing pin 23 which is threaded is located at the top of the castor so that the castor can be secured to a target object such as an item of furniture or a vehicle. Other securing mechanisms may be used.

The wheels 11₁, 11₂, are arranged side by side and separated by a central housing 24. The housing 24 is connected to the top of the castor by a rigid connecting piece 25. In this sense the housing and forks are rigidly secured to a further object by the connecting member 23 and the two wheels will rotate independently with respect thereto. The housing 24 has a groove 26 along part of the circumference which enables the braking foot 14 connected to the arm of the braking member to move from its non-braking position shown in FIG. 2 downwardly until the braking foot separates the wheels of the castor from the ground surface 27.

FIG. 3 illustrates the braking foot 14 in a non-braking mode of operation whilst FIG. 4 illustrates the brake foot in a braking position. In the braking position the foot 14 is rotated downwardly from the position shown in FIG. 3 until the foot is juxtaposed between the running surface 27 and the wheel 11. It will be understood that in this position a user pushing the object to which the castor is connected (not shown) will be hindered considerably in movement.

FIG. 5 illustrates deployment of the braking foot 14 from a braking position to a non-braking position. This occurs when a sensor 50 on the castor body detects a control signal. For example a wireless signal from a transmitter 51. The remote transmitter 51 transmits a first signal 53 which operates to initiate braking when a vehicle or other object to which the castor is connected moves from zone X to zone Y as shown in FIG. 5. This operation will be described in more detail hereinafter. The transmitter 51 also transmits a second signal 52 which is detected by the sensor 50 when the castor moves from zone Y to zone X. As the castor moves over an interface between the zones, the signal 52 is received by the sensor 50 which releases the braking mechanism to thus unlock the braking mechanism. In this sense a user is able to move an object to which the castor is connected within zone X but as soon as movement from zone X to zone Y occurs the braking mechanism retards rotation of at least one of the wheels 11 so that movement of the object becomes impossible or very difficult.

FIG. 6 illustrates the separate parts of the castor in more detail. As may be seen each wheel 11 is formed from a respective wheel body 60 formed from rigid plastic or metal or some other rigid material. Each wheel is substantially circular in cross section and is generally disk-like. About the edge of each wheel 11 is a high friction surface 61 such as rubber which helps ensure the wheels run smoothly over a running surface. Each wheel 11 has an inner side 62 and an outer side 63. The inner side 62 is recessed.

The bolt 20 extends all the way through the two wheels and the wheel housing 24. A dust cover 64 prevents the ingress of dust onto the axle of the wheel which might hinder rotation of the wheels. The dust cover may also act as a string guard.

A spindle 65, which is a generally cylindrical element, is also located along the common axis of the wheels in a coaxial manner from end to end. A further dust cover/string guard 66 is located on the outer side 63₂ of the wheel 11₂ and the threaded end 67 of the bolt 20 is secured with nut 21. The forks 12 (sometimes referred to as the horns) are secured to the nut and bolt so that the wheels 11 will rotate about the axis A.

As illustrated in FIG. 6, the wheel housing 24 is a substantially cylindrical housing having an H-shaped cross section. The outer wall 68 is supported by a central plate 69. The central plate 69 separates two sides of the housing and each side provides a respective compartment C1, C2 in which further equipment of the castor may be located.

FIG. 7 illustrates a first compartment C1 of the housing. FIG. 7 illustrates the housing 24 without the wheel 11₁. A circular rim 70 defines an open mouth of the housing and the braking member 13, including the braking foot 14, is shown in more detail. The braking member includes an arm 71 secured at a first end 15 to the brake foot. The arm extends into a hip region 72 which is arranged to rotate about the axis A. The hip region 72 of the brake includes an extension 73 which is secured to a first end of a biasing spring 74. The extension, hip, arm and foot may be integrally formed. The remaining end of the biasing spring 74 is secured in a fixed position with respect to the housing. In this way the spring operates to urge the braking arm and hip in an anti-clockwise direction thus urging the braking foot 14 upwardly away from a running surface. This is in a non-braking mode of operation. A latch member 76 is pivotally secured to the braking hip and includes a magnet 77 and braking arm 78. The latch member 76 is pivotable about a pivot point 79. The magnet is arranged to present a predetermined pole, for example north, outwards in the direction of the circumferential edge of the wheel housing.

A latch actuating member 80 which is formed from an elongate body is also pivotable between stops 81 and 82. The latch actuator includes a further magnetic element 83. The magnet 83 is arranged along a lower contact surface of the latch actuator 80. Thus one side of the actuator is magnetised generally with a first pole of the magnet whilst a remainder side of the actuator is magnetised generally according to the remaining pole. As illustrated in FIG. 7, when the latch actuator 80 is pivoted anti-clockwise until it abuts with end stop 82, the end at which the second magnet is located is a substantial distance away from the latch 76. In this position the latch is arranged such that the latch is repelled downwardly by virtue of the north pole of the magnet 77 on the latch being presented to the matching north pole end of the actuator magnet 83. In this way whilst the magnet 77 is arranged extending away from the latch/actuator contact surface of the latch the magnet 83 is arranged along the corresponding surface of the actuator thus revealing north and south poles.

FIG. 8 illustrates a further setting of the latch and latch actuator in which the latch actuator 80 is pivoted clockwise until it abuts with a second end stop 81. In this position the south pole of the magnet 83 is more closely presented to the north pole facing out from the magnet 77. The magnets are thus arranged so as to be attracted with a significant strength and thus the latch 76 is attracted towards the end of the latch actuator 80. This moves the latch into a second and activated position. In this position the latch arm 78, which extends outwardly from the latch body in a direction out of the page shown in FIGS. 7 and 8, moves from a first position in which it is radially proximate to the central axis A to a second position in which the radial distance from the central axis is increased.

FIGS. 9A, 9B and 9C illustrate the inner side 62₁ of the first wheel 11₁ (not shown in FIGS. 7 and 8) in more detail. It will be noted that the annular recess inside the wheel includes one toothed region 90. One such region is sufficient but having a plurality of such regions means that braking occurs more promptly when required. The toothed region is formed from a substantially circular wall 91 which extends outwardly from a central flat zone 92. The wall 91 has a V-shaped portion 93 with the apex of the V-shaped tooth having an engaging lip 94. Each wall region 91 provides a distance R₁ which is greater from the central axis than a corresponding radius R₂ in a region where the toothed region is located. As will be understood by those skilled in the art when the arm 78 of the latch 76 is in the first position, as illustrated in FIG. 9B, the arm is relatively speaking close to the axis. In this sense the arm has a distance from the axis A around R₃. As such the arm in this position does not engage with a toothed region 90 on the inside of the first wheel. However, when the latch actuator 80 is rotated to move closer to the latch 76, the magnetic forces of attraction pull the latch 76 about its pivot point 79 into a position in which the arm 78 is radially further away from the axis A. As the wheel rotates a toothed region 90 will thus come into contact with the arm. This is illustrated in FIG. 9C. The arm 78 will in fact engage with an abutment surface 94 of one of the toothed regions. As the wheel 11 continues to move, the abutment of the surface 91 drives the braking member by virtue of the fact that the latch 76 is connected to the brake. The drive causes the braking arm 71 in a clockwise direction against the biasing force of the spring 74. Movement of the wheel caused by a user pushing thus drives the braking foot into a braking position.

When a brake is to be disengaged, for example, when the castor passes back into an authorised zone and thus receives a reset signal from the remote transmitter, the latch actuator 80 is rotated until it hits the first abutment 82. This moves the south pole of the magnet 83 away from the north pole of the magnet 77. The north pole of the magnet 83 is then effectively presented again to the north pole of the magnet 78 of the latch which causes the latch to be biased away from the latch actuator. This moves the latch arm 78 radially towards the wheel axis A thus disengaging the arm from a previously engaged toothed region. The biasing forces of the spring 74 then acts to return the braking arm into a non-braking position thus enabling the wheel to continue onwards unretarded.

It will be understood that the above-described embodiments include a magnetic element in both the latch actuator 80 and latch 76. However, it will also be understood that only one of the actuator and latch need have such a magnetic element. For example, the actuator could include a magnet and the body of the latch 76 could be wholly or substantially metallic. In this way the magnet would attract the metallic body in much the same way as the two magnets are attracted. It will also be understood that more than one magnet could be used on any one of the latch or latch actuator. As an alternative, magnets could be arranged so as to repel each other when in an ‘unlock’ configuration in which case a biasing member, such as a spring (not shown) would be employed to tend to drive the latch into a braking position with the magnetic forces of repulsion being used to overcome this biasing force to disengage the brake.

FIG. 10 illustrates a reverse side of the housing 24 to that shown in FIGS. 7 and 8. The housing wall 68 ends in a second rim 100 which defines an open mouth of the housing. This open mouth defines the second compartment C2 referred to with respect to FIG. 6.

FIG. 11 illustrates a section through line Z-Z shown in FIG. 10. The actuator 80 pivots about pivot point B and is connected from the first compartment C1 side to the second compartment C2 side of the housing by a drive shaft 101. The drive shaft 101 extends from the latch actuator through the central plate 69 of the castor housing where it is connected to a rotating ear 102. As the rotating ear 102 moves from right to left this rotates the drive shaft 101 which causes a corresponding rotation of the latch actuator 80. The rotating ear 102 is driven by a first solenoid unit 103 and a second solenoid unit 104. In this sense the movement of the switch is created by two opposing solenoids. Solenoids are only able to hold their position when they have power running through them. Due to the very limited availability of power in the castor it is preferable to pulse the solenoids to move from the first to a second position and then use a second solenoid to pulse back to the first position. The plunger 105 of the first solenoid is connected to the plunger 106 of the second solenoid 104 by a connector 107 which is generally U-shaped. In this sense a pulse may be driven into the coil of the first solenoid 103 to extend the plunger thus extending the connected plungers from left to right in FIG. 10. This causes a corresponding counter clockwise rotation of the rotating ear 102 and thus the latch actuator 80 is driven into the braking position. When a non-braking position is desired a pulse is driven into the solenoid 104 thus moving the rotating ear towards the left hand side of FIG. 10 thus driving the latch actuator away from the latch mechanism. Having oppositely facing solenoids thus provides an electrically efficient mechanism. When more power is available only one such solenoid unit is needed. It will be appreciated that other methods of driving the latch may be envisaged. For example, one or more motors could be used.

FIG. 10 also illustrates how power may be generated in the castor, in particular in one of the compartments C2. The power generating includes use of a drive belt which extends about an outer rim surface of a central drive ring 109. This drive ring 109 rotates as the wheels of the castor rotates as will be described hereinafter and the rotation of the drive ring is transferred to the drive belt 108. The drive belt is also connected to a further drive ring 110 which forms a drive ring connected to a rotor of a generator unit. As the drive belt 108 is turned by rotation of the central drive ring 109, the drive ring 10 is rotated in a corresponding manner. This rotates a rotor in the power generating unit. The rotor includes a magnetic element which is surrounded by a coil. As the magnet rotates within the coil current is induced in the wires of the coil and this current forms the basis of power for the castor. The power may be stored in a rechargeable battery (not shown) carried by the castor or may be used directly to provide power to the braking mechanism as afore-mentioned. Alternatively, the power may be transmitted through the castor up through the connecting fixing 23 into the object to which the castor is connected where the power may be utilised for a variety of different reasons.

It will be understood that embodiments of the present invention can use power generation on the castor as a wake-up signal for the on board (or rather on-castor) circuitry. In this way a power saving protocol can be implemented with power down taking place a predetermined time after power is generated and power on occurring when it is determined that power is being generated.

FIG. 12 illustrates a cross section through the castor in more detail and helps clarify how the drive belt 108 is secured to the drive ring 109. The drive ring 109 forms a substantially circular rim to a connecting piece 120. The connecting piece 120 includes a substantially cylindrical sleeve section 121 which includes at a first end thereof a crenulated contact surface 122 which includes raised and lower portions. The inner surface 62₁ of the wheel body 60₁ has mating crenulations including extensions and recesses. The end of the connector sleeve 121 and wheel body 60₁ can thus be interlocked so that movement of the wheel 60, transfers into movement of the connecting cylinder 121 of the connector 120. A further end of the connecting cylinder 121 also includes similar crenulations which are provided to mate with corresponding crenulations on the inner surface 62₂ of the second wheel 11₂. In this way movement of the second wheel 11₂ is transferred into rotation of the rotating sleeve 121. A further advantage of connecting the wheels to the connector 120 in this manner is that both wheels will thereby be forced to move together. In this sense one wheel cannot move independently of the other. This has the advantage that since the braking mechanism is only applied to one wheel of the castor, the other wheel is automatically retarded. This avoids the possibility of one wheel being able to continue to turn even though the other wheel is retarded. As an alternative the wheels may be secured to the connecting piece by other techniques such as welding or gluing.

The cylindrical connecting sleeve 121 and its crenulations are integrally formed with the drive ring 109 which extends outwardly from the second end region of the connector 120. The outer surface 123 of the drive ring 109 includes an indented channel in which the drive belt 108 runs. In this way the connection of the two wheels so as to move in a common manner has the advantage that if only one of the wheels is in contact with the ground and caused to rotate, that rotation will provide drive to the drive ring and thus to the drive belt.

FIG. 13 illustrates how the generating unit 130 can be electrically connected to the solenoids 103 and 104 and to a further electrical housing 131 which is arranged on the castor and which holds a castor PCB 132 which is connected to a sensor 50 to receive the remote signals which cause the setting or unsetting of the brake. A wireless signal from a remote transmitter is advantageously focused by a lens 133 which remains uncovered at all times when the castor is connected to a vehicle or object. The lens 133 focuses the received signal onto the sensor 50 and the PCB then controls operation of the solenoids to deploy or unset the braking member as appropriate. Power for the on-board circuitry and components is powered by the generating unit 130. It will be understood that embodiments of the present invention can utilise more than one generating unit on a castor. Referring to FIG. 10, the ghost location 134 is provided to optionally house a second generating unit and it will be appreciated that if this is utilised the drive belt 108 would also be extended over the slave drive ring 110 of the further generating unit.

Use of the sleeve generally located around the central shaft of the wheel and having teeth which locate permanently into corresponding teeth of the wheel has a number of advantages. In particular, consistent drive can always be maintained without damaging the spindle of the stepper motor of the generating unit due to the flexible nature of the belt and the central nature of the drive through the sleeve. Use of the sleeve also means that the castor is relatively easy to assemble, service and resistant to ingress of dirt.

FIG. 14 illustrates how embodiments of the present invention can be utilised in a manner compatible with use of castors on shopping carts in an environment where the shopping carts are to be held in place on a travelator or escalator in a retail environment. Each wheel 140₁, 140₂ of the castor includes a central slot 141₁, 141₂ which is sized to encompass upwardly extending walls 142 on an upper surface of the travelator. When this occurs the bottom part of the housing between the wheels includes an engagement surface 143 which contacts an upper surface 144 of multiple walls. This disengages the wheels from the running surface and effectively locks the shopping cart in place whilst on the travelator.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus for providing a castor for a shopping cart, comprising:
a first wheel member and a second wheel member arranged in a side-by-side configuration on either side of a central wheel housing, each of said first and second wheel members being arranged to rotate about a common wheel axis; and
an elongate sleeve member extending through said housing and connecting said first and second wheels together whereby the two wheels rotate together.

2. The apparatus as claimed in claim 1, further comprising:
the sleeve member connects the first and second wheel members to thereby prevent rotation of only one wheel member.

3. The apparatus as claimed in claim 1, further comprising:
said sleeve member comprises a substantially cylindrical body portion arranged coaxially with a central spindle defining the common wheel axis.

4. The apparatus as claimed in claim 3, further comprising:
the sleeve member further comprises a first wheel engaging surface at a first end region of said sleeve member for engaging with an inner surface of said first wheel; and
a second wheel engaging surface at a second end region of said sleeve member for engaging with an inner surface of said second wheel.

5. The apparatus as claimed in claim 4, further comprising:
said first and second wheel engaging surfaces comprise crenulated surface regions; and
said inner surface of each wheel member comprises corresponding crenulated surface regions; wherein matching male and female extensions and recesses on the crenulated surface regions mate together in an interlocking fashion to thereby translate rotation of any one wheel into rotation of both wheels.

6. The apparatus as claimed in claim 1, further comprising:
the wheel housing comprises a braking assembly arranged to selectively retard rotation of a one of said first and second wheel members, the wheels being connected together via said sleeve member such that retardation of said a one wheel member causes corresponding retardation of a remainder wheel member.

7. The apparatus as claimed in claim 1, further comprising:
the wheel housing comprises at least one power generating unit for generating power for said castor when a wheel member rotates.

8. The apparatus as claimed in claim 1, further comprising:
a support member having an upper connecting element securable to an underside of a shopping cart; and
forks between which said first and second wheel members and central wheel housing are locatable, a spindle about which the wheels rotate being connected at respective ends of the forks.

9. The apparatus as claimed in claim 1, further comprising:
each of said first and second wheel members are substantially circular and comprise an outer rolling edge region located circumferentially around the wheel, the rolling edge region comprising a high friction material.

10. A method for manufacturing a castor for a shopping cart, comprising:
providing a first wheel member and a second wheel member;
arranging each wheel member in a side-by-side configuration on either side of a central wheel housing, each of said first and second wheel members being arranged to rotate about a common wheel axis; and
connecting said first and second wheel members together via an elongate sleeve member whereby the two wheels rotate together.

11. The method as claimed in claim 10 further comprising connecting said first and second wheel members together by securing each wheel member to a respective end of said sleeve member.

12. The method as claimed in claim 11 further comprising securing each wheel member by gluing.

13. The method as claimed in claim 10, further comprising the steps of:
connecting said first and second wheel members together by the steps of:
locating the sleeve member coaxially with a spindle of the castor; and
interlocking crenulations on either end of the sleeve member with corresponding crenulations formed on respective inner surfaces of each wheel member; whereby as a one of said wheel member rotates, a corresponding rotation of a remainder wheel member results.

14. The method as claimed in claim 10, further comprising the steps of:
connecting forks of a support member of a castor to respective ends of a spindle of the castor.

15. (canceled)

16. (canceled)
